(19) United States
(12) Patent Application Publication
(10) Pub. No.: US 2015/0275991 A1
(43) Pub. Date: Oct. 1, 2015

(54) BRAKE ACTUATION DEVICE

(71) Applicant: DECONCEPTS PTY LTD, Bundanoon, New South Wales (AU)

(72) Inventor: Craig Joshua De Leon, Bundanoon (AU)

(21) Appl. No.: 14/432,956

(22) PCT Filed: Sep. 27, 2013
(86) PCT No.: PCT/AU2013/001110

§ 371 Date: Apr. 1, 2015

(30) Foreign Application Priority Data
Oct. 1, 2012 (AU) 2012904265

(51) Int. Cl. F16D 65/14; B60T 8/17

(52) U.S. Cl. CPC F16D 65/14; B60T 8/1708; F16D 2121/24

(57) ABSTRACT

A brake actuation device for a vehicle trailer including a mounting for mounting relative to the trailer, an actuator arranged to be coupled to a braking system of the trailer and movable to actuate the braking system, a movement driver for driving movement of the actuator, a sensor for sensing a predetermined condition, and a controller in communication with the sensor and arranged to operate the movement driver in response to the sensor detecting the predetermined condition, wherein the device has a locked condition in which the actuator is mechanically locked in position.

### FIELD OF THE INVENTION

The invention relates to a brake actuation device and, more particularly, but not exclusively, to an improved brake actuation device for a vehicle trailer, which among other advantages prevents unwanted brake actuation during reversing.

### BACKGROUND OF THE INVENTION

It is common to tow a trailer behind a vehicle, for example, to tow a boat, motorcycles, work equipment, rubbish, and the like. Some trailers are not provided with braking systems (“unbraked” trailers), whereas other trailers (“braked” trailers) are fitted with braking systems. Typically, braked trailers are able to tow a larger load than unbraked trailers as they do not rely solely on the braking system of the towing vehicle. The reliance of unbraked trailers on the braking system of the towing vehicle results in reduced braking efficiency and an increased risk of instability of the trailer.

Although braked trailers enable a user to carry an increased load more safely, the applicant has identified shortcomings in previous trailer braking systems, as discussed below in greater detail.

### Overrun Brake Actuator

One form of existing trailer braking system utilizes an overrun brake actuator. Trailers with 750 kg-2000 kg GTM can utilize an overrun brake actuator. Typically overrun mechanisms are connected to either a cable operated braking system or a hydraulic operated braking system. In either case, the brake system can employ a disc brake or a drum brake fitted to the wheels of only one axle. Overrun mechanisms typically form the coupling between the tow vehicle and trailer.

The applicant has identified that problems with systems of this type include the following:
1. The nature of the overrun implies that to activate the brake on the trailer a force must exist between the tow vehicle and the trailer, this force is significant and is effectively pushing the tow vehicle. The magnitude of the force pushing the tow vehicle is directly proportional to the weight of the trailer and the rate of deceleration.
2. When the trailer is reversed up an incline, the trailer's brakes are applied due to the overrun characteristics. To circumvent this, a typical overrun mechanism employs a latch that the operator uses to “lock out” the overrun function. It is the responsibility of the operator to ensure that this latch is rotated back to the normal position when driving forward to ensure the service brakes return to their normal function. However, this leads to situations in which the trailer's brakes do not function when required.
3. Frequently, systems that utilize a cable to operate the trailer brakes are not adjusted sufficiently by the operator. This results in situations where the trailer is felt to “thump” as the slack in the cable is suddenly taken up by the overrun mechanism or the overrun mechanism runs out of stroke and hits the “end stop”. Both scenarios significantly reduce the effectiveness of the trailer brakes and in extreme cases may in fact mean there is no braking effort from the trailer at all, placing significant additional load to the tow vehicle's braking system.
4. In hydraulic systems employing overrun actuators problems arise from insufficient line pressures due to poorly sized components or from poorly bled brake lines. These problems manifest in poor trailer braking performance.

### Electric Brakes

Another form of existing trailer braking system utilizes electric brakes. Electric brakes can be fitted to trailers from 750 kg to 3500 kg GTM, trailers over 2000 kg having additional requirements to meet regulations. Depending on the size of the trailer, electric brakes may be fitted to the wheels of one axle or as many as three axles of the trailer. Electric brakes employ a device that is fitted to the tow vehicle which determines the required brake output, and various different methods of determining the required brake output are employed by a variety of vendors. A control device fitted to the tow vehicle is referred to as an “In-Car Controller”. The In-Car Controller's main function is to provide and modulate the power to the electric brakes fitted on the wheels of the trailer. The power provided by the In-Car controller is converted to an actuation force by way of electro magnets. Electric brakes are typically in the form of drum brakes.

A secondary function of the In-Car Controller is to provide a “Trailer Brakes Only” function to the operator. The idea behind this function is that the operator can apply the trailer's brakes to “pull out” trailer swing. Although this concept works well more often than not, the operator is too busy concentrating on driving and simply forgets or cannot access the override button/lever effectively. With good quality electric brakes and In-Car Controllers, brake performance can be well modulated with good performance.

However, the applicant has identified that problems with systems of this type include the following:
1. In-Car Controllers are costly, and require qualified technicians to install.
2. In-Car Controllers are cumbersome and are required to be fixed to the interior of the tow vehicle within reach of the driver, normally being placed under the steering column or on the dashboard. This poses a significant safety issue with regard to modern vehicles and airbag deployment as well as considerable aesthetic issues.
3. In-Car Controllers come in a vast range of sizes and power ratings, resulting in situations where an In-Car controller with a low power rating may be used in conjunction with a trailer equipped with brakes on two or three axles. In this case the In-Car controller may not provide sufficient power therefore brake performance may be dramatically reduced.
4. Trailers fitted with electric brakes can only be towed by vehicles fitted with In-Car Controllers, and as highlighted in item 3, above, care needs to be taken to ensure the In-Car Controller is of a suitable power rating.
5. Due to their design, Electric Brakes are prone to corrosion of the drum brake and electrical connections. This limits the application of electric brakes to markets such as caravans and horse floats where the trailers are not subject to being submerged in water, such as the case with boat trailers and off road caravans.
6. Due the electric brake system being prone to corrosion a trailer with electric brakes needs to be stored in an environment that does not promote corrosion.
7. As may be mandated in some jurisdictions, trailers over 2000 kg GTM require an automated function to apply the trailer brakes in the event of the trailer becoming dislodged from the tow vehicle—this being referred to as a “Break Away”. Regulations state ‘In the event of a Break Away the trailer brakes must be capable of stopping the trailer and holding the trailer stationary for at least 15 min.’ In an electric brake system the typical way of achieving this is to employ a large 12 v lead acid battery that is electrically connected to the electric brake circuit when a Break Away event occurs. The battery creates additional problems in that the vehicle operator must be aware of the charge level of the battery. If the charge level is insufficient to hold the brakes on for the required duration the battery must be charged which can take significant time. The trailer should not be towed until there is sufficient charge within the battery.
8. In addition, as there is no control mechanism remaining with the trailer, when a Break away event is triggered, the trailer brakes are applied to full braking effort instantaneously.

### Electro Hydraulic or Electro Pneumatic Hydraulic Brake Actuators

Electro Hydraulic or Electro Pneumatic Hydraulic Brake Actuators can be fitted on trailers from 750 kg to 3500 kg GTM, with trailers over 2000 kg having additional requirements to meet regulations. These styles of brake actuators are devices that generate hydraulic pressure by employing hydraulic or pneumatic pumps powered by the tow vehicle; the power being supplied by means of an In-Car Controller or proprietary In-Car Controllers. These styles of actuators are connected hydraulically to Disc Brakes. Depending on the size of the trailer, brakes may be fitted to the wheels of one axle or as many as three axles.

Electro Hydraulic actuators operate by driving a hydraulic pump during the braking event. The speed the Hydraulic pump is driven depends of the line pressure required. Electro Pneumatic Hydraulic actuators charge a pneumatic accumulator, the accumulated pressure is regulated and transferred to hydraulic pressures and then regulated into the brake line during Brake Events as per the required line pressure. A well maintain system has good modulation with good braking performance. With these systems corrosion is not a significant problem as the actuator can be installed in a manner that limits the exposure to harsh environments. These systems are typically installed with disc brakes which are also much more robust in harsh environments.

The applicant has identified that problems with systems of this type include the following:
1. Electro Hydraulic Actuators are designed to pump brake fluid at full line pressure. To achieve this, hydraulic pumps with complex design and manufacture techniques are required. This creates a significant expense and accordingly this style of actuator is only used on large boat trailers over 2000 kg GTM, where the cost of the device may be justified by the operator.
2. These actuators also require the use of In-Car Controllers typically used in electric brake systems, accordingly these systems have the same problems associated with the In-Car Controllers of the electric brake systems, such as further expense, fitment by technicians, and fitment to interior of tow vehicle etc.
3. Actuators that drive the pump while braking require a significant amount of power and therefore an In-Car Controller must have a very high power rating. In some cases it is necessary to fit an extra power supply line to the tow vehicle so that the high power can be delivered to the actuator. This often means that a specific trailer is to be towed by a specific vehicle.
4. Actuators that pump up a pneumatic accumulator to store pressure typically draw a lower current over a longer duration, but they require proprietary In-Car Controllers. The significant problem with this accumulation method is that the accumulator may become depleted when the Brake Event duty cycle is high, thus brakes may be unavailable or severely reduced in performance until the accumulator has time to recharge.
5. Vehicles fitted with Proprietary In-Car Controllers can only be used to tow trailers fitted with matching brake systems. This generally means the trailer has a designated tow vehicle.
6. As per electric brake systems, trailers over 2000 kg GTM must have a break away system that can stop the trailer and hold the trailer stationary for 15 min. To achieve this, actuators that drive the pump during a brake event may employ a large 12 v lead acid battery that is electrically connected to the actuator in the event of a break away. As discussed above, in the section on electric brakes, a battery for break away events creates additional maintenance problems. Alternatively, actuators that store energy in an accumulator do not require a 12 v lead acid battery, as the stored pressure in the accumulator is available for the break away event.

The applicant has determined that it would be beneficial for there to be provided an improved brake actuation device which provides increased safety, convenience, reliability and/or affordability over existing systems. Examples of the present invention seek to provide an improved brake actuation device which overcomes or at least alleviates one or more disadvantages associated with previous trailer braking arrangements.

### SUMMARY OF THE INVENTION

In accordance with one aspect of the present invention, there is provided a brake actuation device for a vehicle trailer including a mounting for mounting relative to the trailer, an actuator arranged to be coupled to a braking system of the trailer and movable to actuate the braking system, a movement driver for driving movement of the actuator; a sensor for sensing a predetermined condition, and a controller in communication with the sensor and arranged to operate the movement driver in response to the sensor detecting the predetermined condition, wherein the device has a locked condition in which the actuator is mechanically locked in position.

Preferably, the movement driver is powered by a power source, and the locked condition is independent of supply of power from the power source to the brake actuation device. More preferably, in the locked condition, the actuator is mechanically locked in position relative to the mounting.

In a preferred form, the powered movement driver is a motor. More preferably, the locked condition is provided by way of said motor having a worm drive arranged to allow drive transmission from the motor to the actuator and to prevent drive transmission from the actuator to the motor.

Alternatively, the locked condition is provided by way of a one way clutch.

In one form, the locked condition is provided by way of a drive type of the movement driver.

Preferably, the movement driver is powered by at least one capacitor.

In accordance with another aspect of the present invention, there is provided a brake, actuation device for a vehicle trailer including a mounting for mounting to the trailer, an actuator arranged to be coupled to a braking system of the trailer and movable to actuate the braking system, a movement driver for driving movement of the actuator, a sensor for sensing a predetermined condition, and a controller in communication with the sensors and arranged to operate the movement driver in response to the sensor detecting a predetermined condition, wherein the movement driver is powered by at least one capacitor.

Preferably, the movement driver is powered by a plurality of capacitors. More preferably, the movement driver is powered by a bank of capacitors. Even more particularly, the or each capacitor is a supercapacitor.

In a preferred form, the capacitor(s) is/are mounted relative to the trailer. More preferably, the capacitor(s) is/are mounted relative to the device.

In accordance with another aspect of the present invention, there is provided a brake actuation device for a vehicle trailer including a mounting for mounting to the trailer, an actuator arranged to be coupled to a braking system of the trailer and movable to actuate the braking system, a movement driver for driving movement of the actuator, a sensor for sensing a predetermined condition, and a controller in communication with the sensor and arranged to operate the movement driver in response to the sensor detecting a predetermined condition, wherein the sensor includes an accelerometer.

Preferably, the accelerometer is a multi-axis accelerometer.

In a preferred form, the accelerometer is mounted relative to the trailer. More particularly, the accelerometer forms part of the device.

Preferably, the accelerometer is arranged to sense lateral acceleration of the trailer, and the controller is able to monitor predetermined events of amplitude and/or frequency of lateral acceleration. More preferably, the controller is adapted to gradually increase brake activation force once an event is detected. Even more preferably, the controller is adapted to increase the rate of application of the brake activation force if amplitude of lateral acceleration increases during gradual increase of brake activation force following detection of said event. In a preferred example, the sensor includes a load cell, motor position sensor and/or other sensors that monitor the condition of the device.

Preferably, the device automatically runs a calibration routine to determine a position the actuator returns to when no brake activation force is required.

In accordance with another aspect of the present invention, there is provided a brake actuation device for a vehicle trailer including a mounting for mounting relative to the trailer, an actuator arranged to be coupled to a braking system of the trailer and movable to actuate the braking system, a movement driver for driving movement of the actuator, a sensor for sensing a predetermined condition, and a controller in communication with the sensor and arranged to operate the movement driver in response to the sensor detecting the predetermined condition, wherein the device has a retained condition in which the actuator is retained in position.

Preferably, in the retained condition the actuator is mechanically restrained against movement to maintain braking force of the braking system.

Preferably, the movement driver is powered by a power source, and the retained condition is independent of supply of power from the power source to the brake actuation device.

Alternatively, the movement driver is powered by a power source, and the retained condition is achieved mainly through mechanical retention of the actuator with only a minimal supply of power from the power source to the brake actuation device being required.

Preferably, in the retained condition the actuator is mechanically retained in position relative to the mounting by a highly geared drive between the actuator and the powered movement driver, said drive being reversible such that it allows drive transmission from the movement driver to the actuator and drive transmission from the actuator to the movement driver.

### BRIEF DESCRIPTION OF THE DRAWINGS

The invention is described, by way of non-limiting example only, with reference to the accompanying drawings, in which:.

FIG. 1 is a perspective view of a brake actuation device in accordance with an example of the present invention;

FIG. 2 is a top view of the brake actuation device;

FIG. 3 is a side view of the brake actuation device;

FIG. 4 is a side perspective, view of the brake actuation device, shown with a sealed housing removed;

FIG. 5 is a top view of the brake actuation device, shown with the sealed housing removed;

FIG. 6 is a side view of the brake actuation device, shown with the sealed housing removed;

FIG. 7 is an opposite side perspective view of the brake actuation device, shown with the sealed housing removed;

FIG. 8 is an opposite side view of the brake actuation device, shown with the sealed housing removed;

FIG. 9a is an end view of the brake actuation device, shown with the sealed housing removed, and FIG. 9b is a cross-sectional view taken along line A-A;

FIG. 10a is a side view of the brake actuation device, shown with the sealed housing removed, and FIG. 9b is a cross-sectional view taken along line B-B;

FIG. 11 is a side view of the brake actuation device, shown with an electric power supply cable removed; and

FIG. 12 is a diagrammatic view of the brake actuation device.

### DETAILED DESCRIPTION

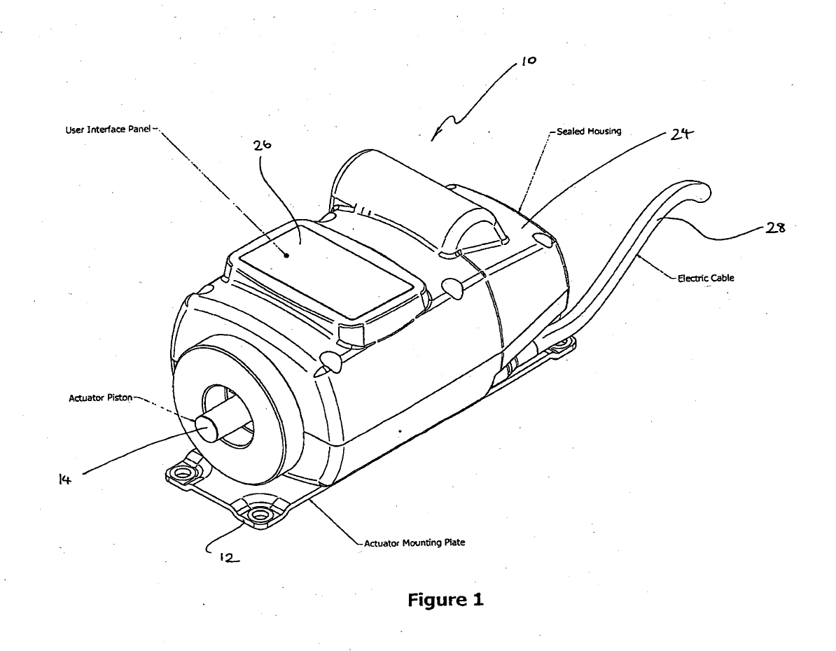

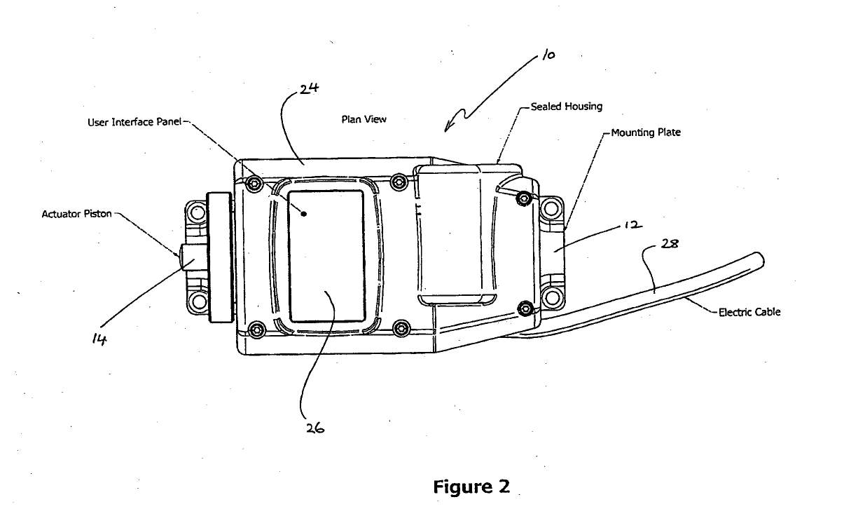

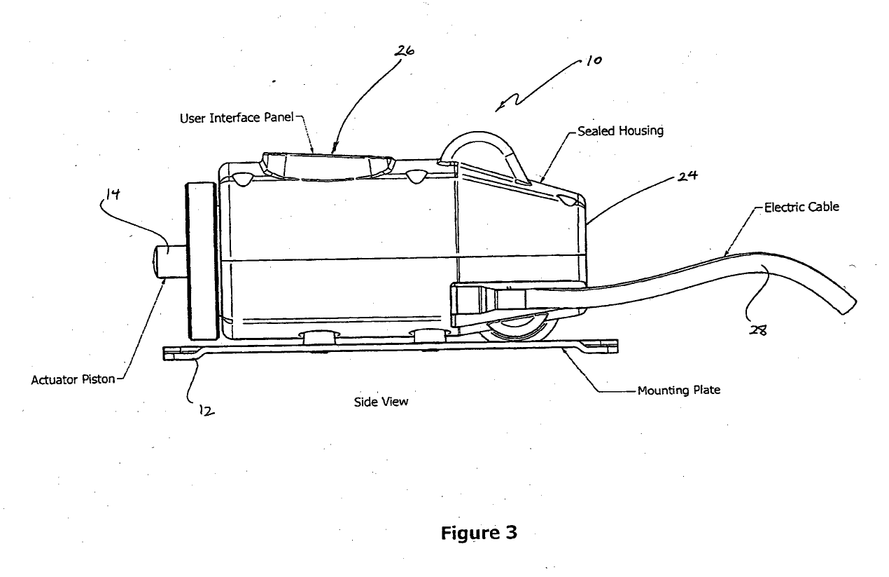

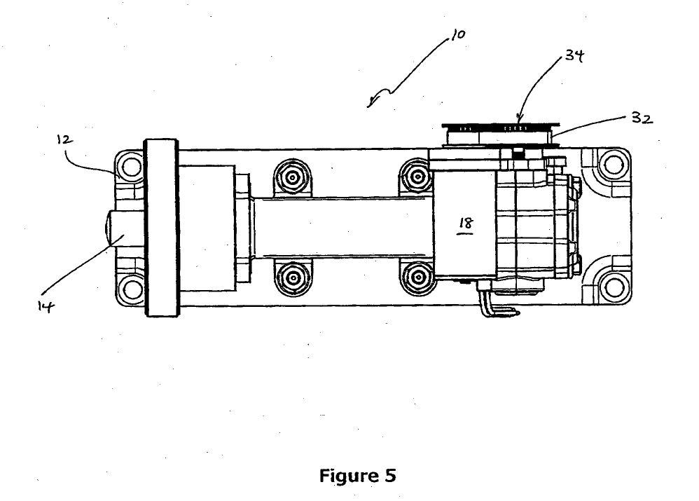

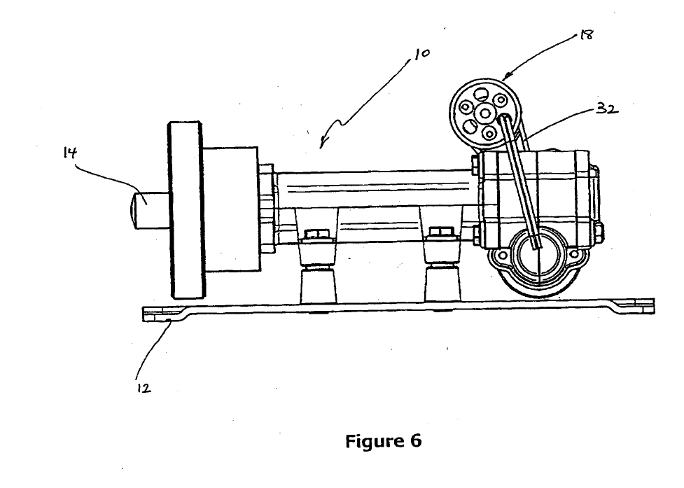

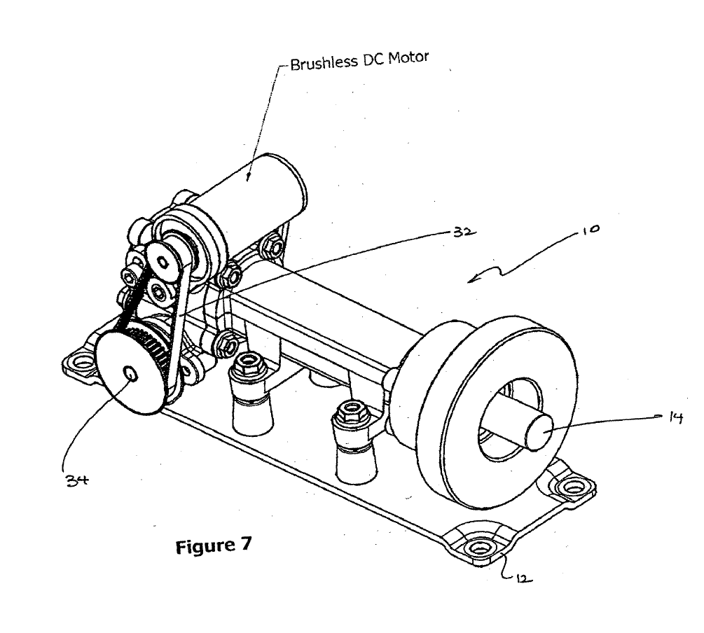

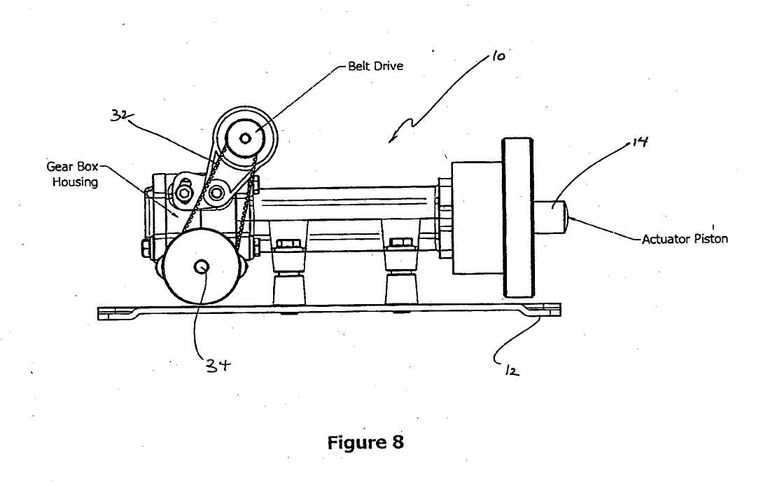

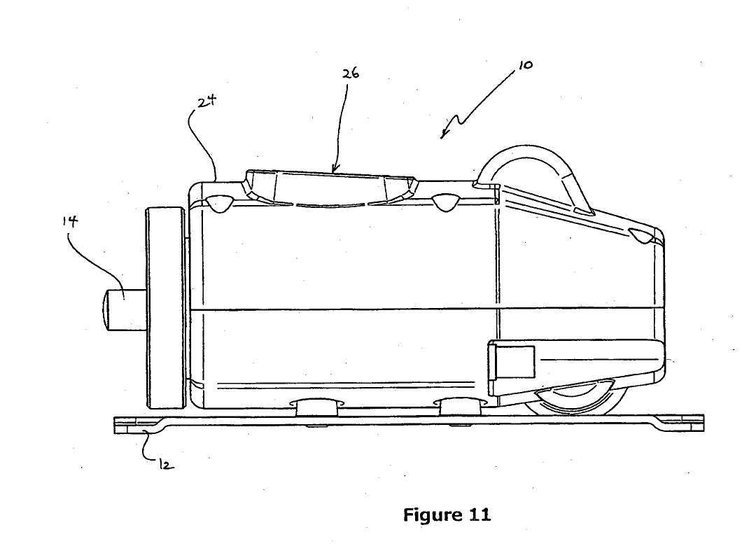

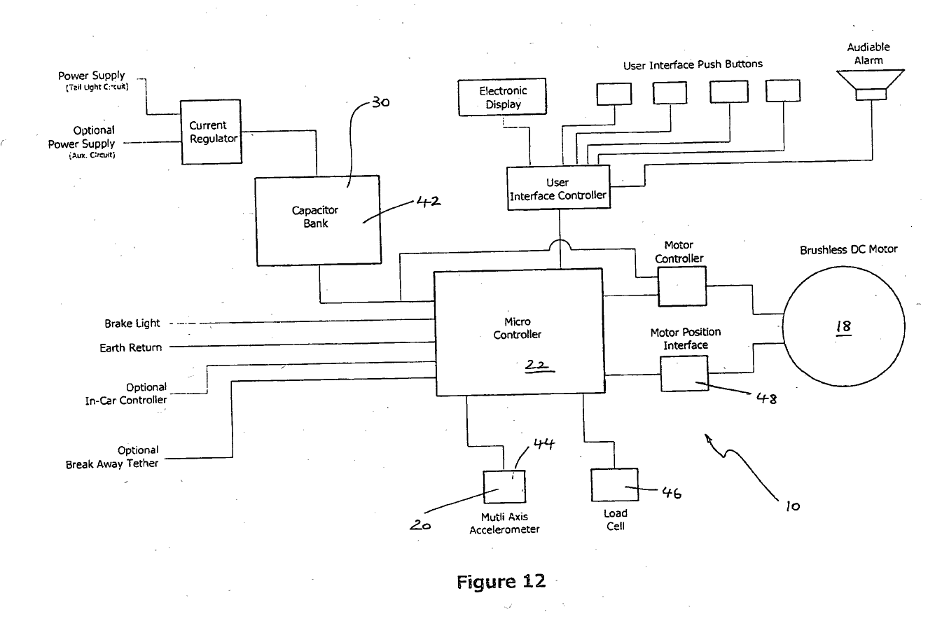

FIGS. 1 to 12 show a brake actuation device 10 in accordance with a preferred example of the present invention. The brake actuation device 10 is for a vehicle trailer and includes a mounting 12 for mounting the brake actuation device 10 relative to the trailer, and an actuator 14 arranged to be coupled to a braking system of the trailer and movable to actuate the braking system. A movement driver 16 is provided in the form of a motor 18 for driving movement of the actuator 14. A sensor 20 (see FIG. 12) is arranged for sensing a predetermined condition, and a controller 22 is provided in communication with the sensor 20 to operate the motor 18 in response to the sensor 20 detecting the predetermined condition. The brake actuation device 10 has a locked condition in which the actuator 14 is mechanically locked in position.

Conveniently, as shown in FIGS. 1 to 3, the brake actuation device 10 is housed within a sealed housing 24, and includes a user interface panel 26 to allow a user to configure operation of the brake actuation device 10. Advantageously, the brake actuation device 10 is able to be conveniently mounted to a trailer by simply attaching the mounting 12 to the trailer in a correct orientation to allow the actuator 14 to operate the braking system of the trailer, and by connecting an electric cable 28 of the brake activation device 10 to a power source 30.

The brake actuation device 10 may be retrofitted to existing trailers, or may be included as standard equipment on new trailers. Advantageously, the brake activation device 10 addresses shortcomings of existing arrangements by conducting regular self-calibration, by providing a locked condition of the actuator 14 where it is mechanically locked in a position (thus not consuming power while the actuator 14 is stationary) and by having the motor 18 powered by one or more capacitors which avoids the drawbacks of existing systems using batteries. Advantageously, the brake actuation device 10 may also use a sensor 20 in the form of an accelerometer mounted to the trailer which provides improved safety and a broad scope for configuring the control system of the brake actuation device 10.

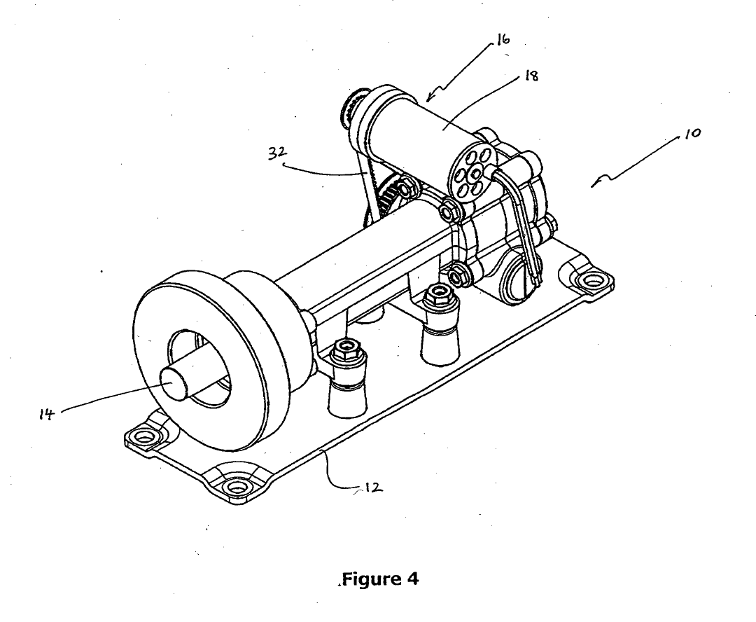

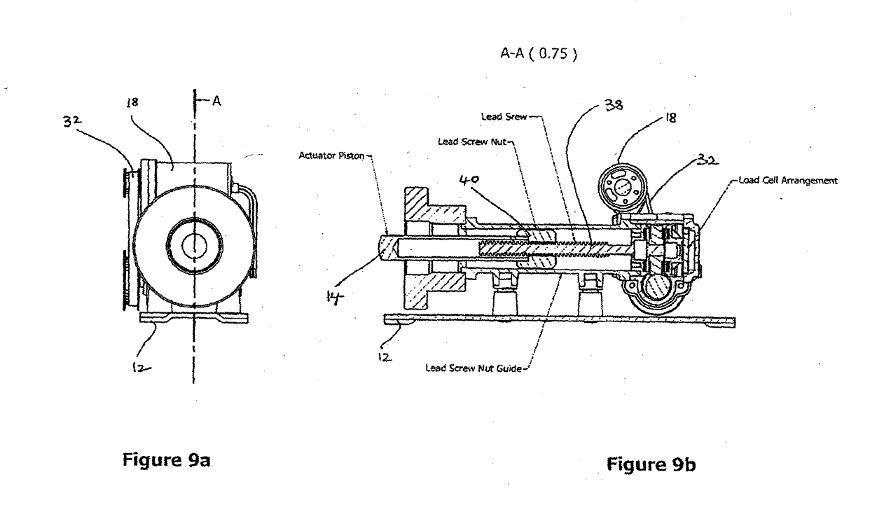

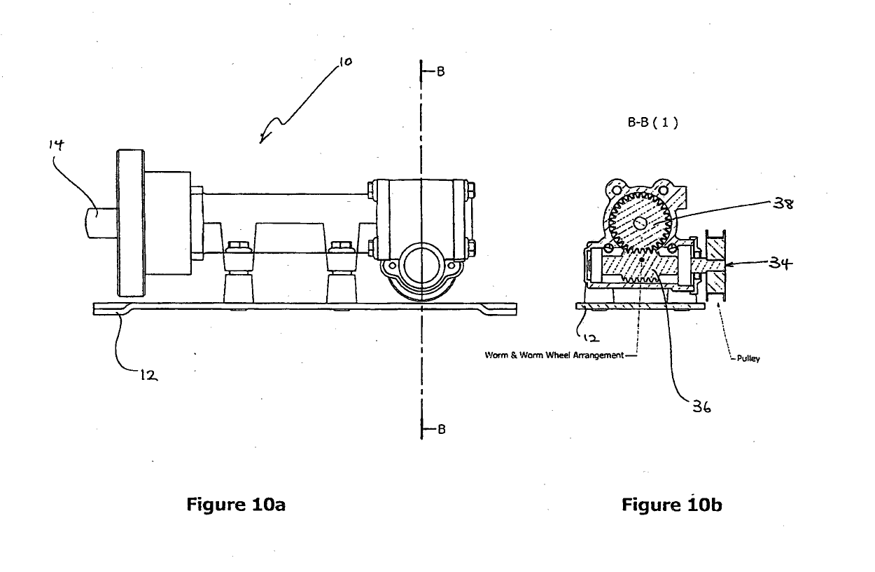

The motor 18 is powered by the power source 30, and the locked condition of the actuator 14 is independent of supply of power from the power source 30 to the brake actuation device 10. In this way, even in the event that the brake actuation device 10 has no power (for example if the trailer were to become detached from the tow vehicle from which it normally receives power), the actuator 14 is able to be held in a condition where the braking system of trailer is fully applied indefinitely, not just for the duration of charge in a portable power supply as is the case in existing battery systems. With reference to FIGS. 4 to 8, the motor 18 drives the actuator 14 by way of a belt 32 which drives a shaft 34. The shaft 34 drives a worm drive 36 (see FIGS. 10a and 10b) which, in turn, drives a lead screw shaft 38. The lead screw shaft 38 rotates within a threaded lead screw nut 40 (see FIGS. 9a and 9b) which is connected to the actuator 14. When the lead screw shaft 38 is rotated, this causes the lead screw nut 40 to move along the lead screw shaft 38, and thus to extend or retract the actuator 14 depending on the direction of operation of the motor 18. However, by virtue of the worm drive 36, drive transmission from the actuator 14 to the motor 18 is prevented by the nature of engagement of the gears of the worm drive 36. Although this arrangement is able to provide the locked condition in the example shown in the drawings, wherein the actuator 14 is mechanically locked in position relative to the mounting 12 without power input required to maintain the locked condition, it is foreseen that alternative methods may be used in other examples, for example by way of a one way clutch.

Although the example shown in the drawings has the powered movement driver 16 in the form of a motor 18, in alternative examples the powered movement driver may take other forms of drive type such as, for example, a hydraulic piston with valves which are normally closed so as to provide the locked condition when power is off.

Advantageously, in the example shown, the motor 18 is powered by at least one capacitor. More specifically, the motor 18 is powered by a capacitor bank 42 in which each of the capacitors is a supercapacitor. The capacitors are mounted relative to the trailer and, more particularly they are mounted relative to the device 10, such that the device 10 is able to receive power from the capacitor bank 42 in the event the trailer is separated from the tow vehicle.

The controller 22 may be in the form of a micro-controller which is communication with the sensor 20 which itself is in the form of an accelerometer, more specifically a multi-axis accelerometer 44. The multi-axis accelerometer 44 makes the device 10 very configurable, and enables predetermined events to be based around lateral, longitudinal and/or vertical acceleration of the trailer. The accelerometer 44 is mounted on the trailer and, preferably, forms part of the brake actuator device 10.

Accordingly, the accelerometer 44 is able to sense lateral acceleration of the trailer, and the controller 22 is able to monitor predetermined events of amplitude and/or frequency of lateral, longitudinal and/or vertical acceleration. The controller 22 may be adapted to gradually increase brake activation force exerted by the actuator 14 once an event is detected, particularly if trailer sway is detected. The rate of increase of the brake activation force may be raised by the controller 22 if amplitude of lateral acceleration of the trailer increases during gradual increase of brake activation force following detection of trailer sway. The brake actuation device 10 may also include other sensors as well as (or instead of) the accelerometer such as, for example, a load cell 46, a motor position sensor 48 and/or other sensors that monitor the condition of the device 10.

The device 10 may automatically run a calibration routine to determine a position the actuator 14 returns to when no brake activation force is required, as will be discussed in greater detail in the example below.

In one variation, the device has a retained condition in which the actuator is retained in position, rather than being locked in position, wherein a very high gearing (for example a gearing of 60:1) is used to effectively retain the actuator in position. This may be achieved by a range of reversible drive types such as, for example, straight cut gears or a worm drive having the angle of the thread on the worm sufficiently offset from the transverse so as to enable drive in both directions, i.e. allowing drive transmission from the movement driver to the actuator and also from the actuator to the movement driver.

In this way, a large portion of the retaining may be provided by virtue of the gearing itself, and any additional retention required may be provided by way of a small current. Accordingly, only a minimal supply of power from the power source to the brake actuation device may be required.

### EXAMPLE

In accordance with one example, there is provided an Electro-Mechanical Trailer Brake Actuator for trailers with GTM 750 kg-3500 kg.

The proposed design is for a brake actuation device, in that the sole purpose of the device is to provide an actuation force for either cable operated brake systems or hydraulic operated brake systems. Either style of brake system is free to utilise either disc brakes or drum brakes as the braking element. The actuator is not necessarily part of the tow coupling.

The brake actuation force is provided by an electric motor driving through various gears, pulleys and screws so that the rotary motion of the electric motor is geared sufficiently to provide appropriate brake actuation force. The resulting brake actuation force may be in the form of pushing, pulling or even rotary as in winding cable onto a drum. In the proposed design, the actuation force is in the form of pushing by a screw jack arrangement.

The device uses a micro-controller connected to several sensors and a user interface. The micro-controller and associated electronics are mounted with the device on the trailer. The design of the device is such that it can be wired into existing circuits of the trailer and there is no requirement to have specific wiring carried out on the tow vehicle other than the standard 5-7 pin connection that is commonly installed when a tow bar is fitted to the tow vehicle. The sensors incorporated into the device are a multi axis accelerometer, a load cell, motor position sensors and various other sensors that monitor the device condition. The device has a user control interface which enables the operator to adjust various operational parameters of the device, and to active various functions of the device.

The device utilises a capacitor bank for energy storage. The use of the capacitor bank is what allows the device to be utilised with standard trailer wiring. The capacitor bank is charged by the tow vehicle through the tail light circuit as this forms a common standard source of constant power. The device's power supply circuit will regulate current so as not to overload the tail light electrical circuit. It is envisaged that the capacitor bank would charge from a completely depleted state to an operational level in approximately one minute with this method.

The Capacitor bank provides the power to the electric motor and electronics; this effectively isolates the tow vehicle from the instantaneous high current required by the electric motor, especially when high brake actuation forces are required. The capacitor bank once fully charged maintains charge for up to 12 hours after being detached from the power supply, thus enabling the device functionality even if the trailer is detached from the tow vehicle. This capacitor bank concept allows high brake event duty cycles typically in the order of 3-4 emergency brake events per minute with current draw not exceeding 4 amps from the tow vehicle.

To complement the capacitor bank, the device only drives the motor forward or reverse when acceleration is not constant. For example, if the vehicle is travelling down a long descent and the operator places his foot on the brake pedal just to maintain the vehicle speed, initially the device will read the accelerometer and calculate the desired brake actuation force. The device will then drive the motor in the desired speed and direction. Once the desired brake actuation force is obtained, power will be disconnected from the motor. The motor will only start up again if the desired brake actuation force moves out of a predetermined tolerance band, this typically leads to average motor run times of less than one second.

In addition to providing service brake functionality the device will also provide automatic calibration and adjustment. The device may frequently run a calibration routine that determines the position to which the brake actuator returns when no brake actuation force is required (referred to as the “Start Point”). The calibration routine effectively looks for a very small change in load applied to the device, and this allows the device to self calibrate.

The same routine is used for either hydraulic or cable operated brake systems, and the routine is as follows:
a. The device initially moves backward from the anticipated start point.
b. The device then moves forward with constant low power applied to the motor.
c. The motor speed is very closely monitored.
d. Once the motor begins to reduce speed continuously it is determined to have started pushing against either the piston in a hydraulic system or the return spring of a cable operated brake system. In either case, the start point is then calculated from the point the motor started to continuously reduce speed.
e. The device then moves back to the calculated start point.

The routine takes less than two seconds to execute, and as such can be programmed to run every time the brakes are applied and subsequently released. In the case that a brake event occurs during the calibration routine, the calibration routine is cancelled and the device functions as normal.

### Park Brake Function

The device simply drives the motor to a predetermined brake actuation force. Due to the selection of gears etc being “non-back driving”, the brake actuation force will be held indefinitely. In the case where this function is employed for long periods such as when the trailer is stored, the capacitor bank will have discharged, in this case the park brake function is still active and when the device is reconnected to power this condition will be recognized. The operator can then simply press an appropriate button on the user interface to deactivate the park brake.

### Automatic Park Brake Release

In the event the operator forgets to remove the park brake before driving off, the device will disengage the park brake function when the operator uses the tow vehicle brakes, as this signals to the micro-controller that the trailer is connected to and controlled by the tow vehicle.

### Break Away Function

In the event of the trailer becoming detached from the tow vehicle, (and assuming a standard Break Away Switch/Tether is installed), a break away event will be triggered. The break away function applies the brakes to a predetermined level. However unlike other systems this break away function will not simply apply 100% brake effort instantly—as the device's micro-controller is mounted with the device on the trailer and the capacitor bank will have sufficient energy stored, a controlled application of the brakes will be employed.

Additionally, like the park brake function, the brake actuation force will remain constant indefinitely, not just the mandatory 15 minutes. This removes the requirement of the large 12 v lead acid battery and associated charge level issues and warnings. To release the brakes the operator would simply use the park brake button provided. Additionally, due to the capacitor bank's stored energy the brakes may be released by the operator allowing the trailer to be moved to a safe location and then the park brake function applied.

### Sway Control

In the event that the trailer begins to sway from side to side, the accelerometer will monitor the lateral motion and look for certain conditions; such as a sine wave with a predetermined amplitude and frequency, once trailer sway event has been triggered the device will gradually increase the brake actuation force. If the trail swing is worsening, the brake actuation force will ramp up quicker. This takes the responsibility away from the operator, and any trailer swing should removed quickly and effectively.

### In-Car Controller

In some cases, legislation may require the use of an In-Car Controller. The device will have the ability to be wired into such a device. Once brake event signals are being delivered to the device via this method, brake actuation forces will respond to the requirements of the In-Car Controller. However, the function of the device will still operate functions such as the park brake, park brake off, break away and sway control.

The In-Car Controller option would also be useful for extreme off road applications where the operator can directly control the trailer brakes in slow speed manoeuvres.

### Benefits of the Proposed System to the Operator

The one device can use industry standard disc brakes or drum brakes in either hydraulic or mechanical form
Extremely high brake actuation force, thus suitable for hydraulic installations
Fast response to brake events
Precise modulation of brake actuation force
Standard Installation requires no extra wiring to the tow vehicle
No In-Car Controller required
Sway control, will detect trailer sway and respond before an operator even realizes the trailer was swaying
Built in break away available when a break away tether is wired to the device
Automatic adjustment, meaning the brakes will always be adjusted to the optimum position
Large 12 v lead acid battery not required for break away events
No waiting around for break away batteries to charge
Device operating parameters are stored with the trailer thus in situations where more than one trailer is towed by a particular tow vehicle the operator does not need to recall the required settings as is the case with electric or electro hydraulic systems

### Technical Benefits of the Device

Micro-controller provides high level of logic
Brushless DC motor, non-wearing, extremely reliable and energy efficient
Simple mechanical design, resulting in cost effective product and high reliability
Motor control knows the absolute position of the motor at all times
Due to the control method, the system is highly energy efficient
Capacitor bank power supply is highly reliable capable of >500,000 cycles, fast charging and capable of delivering large bursts of power
Multi-axis accelerometer mounted on the device enables advanced functions, such as trailer sway detection
Multi-axis accelerometer allows the device to be mounted within ±180° with respect to the direction of travel
Standard installation only requires 3 wires
   1. Tail light for power
   2. Brake light, for brake event trigger
   3. Earth return
Optional installations include:
   1. Auxillary power line, if operators do not want to drive with head lights on
   2. Break away control, with break away tether installed
   3. In-Car Controller operation, if a typical in-car controller is installed to the tow vehicle (the In-Car Controller can be of any power rating as the device only listens to the signal thus does not draw power from the in-Car Controller)

### Advantageous Aspects for Electro Mechanical Trailer Brake Device

Electric motor appropriately geared to provide linear motion for the purpose of developing a brake actuation force
Gear, pulley, and screw selection provides “non-back driving” effect
Accelerometer mounted to the trailer/device
Micro-controller mount to the trailer/device
Capacitor bank energy store/power supply
Device operational parameters stored with the device/trailer
Trailer sway detection and control
Push button park brake function
Automatic park brake release function
Electronic calibration/cable adjustment function

It will be appreciated by those skilled in the art that the user interface may be either an integral part of the device or, alternatively, wirelessly connected to the device.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A brake actuation device for a vehicle trailer including a mounting for mounting relative to the trailer, an actuator arranged to be coupled to a braking system of the trailer and movable to actuate the braking system, a movement driver for driving movement of the actuator, a sensor for sensing a predetermined condition, and a controller in communication with the sensor and arranged to operate the movement driver in response to the sensor detecting the predetermined condition, wherein the device has a locked condition in which the actuator is mechanically locked in position.

2. A brake actuation device as claimed in claim 1, wherein the movement driver is powered by a power source, and the locked condition is independent of supply of power from the power source to the brake actuation device.

3. A brake actuation device as claimed in claim 1, wherein in the locked condition the actuator is mechanically locked in position relative to the mounting.

4. A brake actuation device as claimed in claim 1, wherein the powered movement driver is a motor.

5. A brake actuation device as claimed in claim 4, wherein the locked condition is provided by way of said motor having a worm drive arranged to allow drive transmission from the motor to the actuator and to prevent drive transmission from the actuator to the motor.

6. A brake actuation device as claimed in claim 1, wherein the locked condition is provided by way of a one way clutch or by way of a drive type of the movement driver.

7. (canceled)

8. A brake actuation device as claimed in claim 1, wherein the movement driver is powered by at least one capacitor.

9. A brake actuation device for a vehicle trailer including a mounting for mounting to the trailer, an actuator arranged to be coupled to a braking system of the trailer and movable to actuate the braking system, a movement driver for driving movement of the actuator, a sensor for sensing a predetermined condition, and a controller in communication with the sensor and arranged to operate the movement driver in response to the sensor detecting a predetermined condition, wherein the movement driver is powered by at least one capacitor.

10. A brake actuation device as claimed in claim 9, wherein the movement driver is powered by a plurality of capacitors or a bank of capacitors.

11. (canceled)

12. A brake actuation device as claimed in claim 9, wherein the at least one capacitor comprises at least one supercapacitor.

13. A brake actuation device as claimed in claim 9, wherein the at least one capacitor is mounted relative to the trailer.

14. (canceled)

15. A brake actuation device for a vehicle trailer including a mounting for mounting to the trailer, an actuator arranged to be coupled to a braking system of the trailer and movable to actuate the braking system, a movement driver for driving movement of the actuator, a sensor for sensing a predetermined condition, and a controller in communication with the sensor and arranged to operate the movement driver in response to the sensor detecting a predetermined condition, wherein the sensor includes an accelerometer.

16. A brake actuation device as claimed in claim 15, wherein the accelerometer is a multi-axis accelerometer or mounted relative to the trailer.

17. (canceled)

18. A brake actuation device as claimed in claim 15, wherein the accelerometer forms part of the device.

19. A brake actuation device as claimed in claim 15, wherein the accelerometer is arranged to sense lateral acceleration of the trailer, and the controller is able to monitor predetermined events of amplitude and/or frequency of lateral acceleration.

20. A brake actuation device as claimed in claim 19, wherein the controller is configured to (i) gradually increase brake activation force once an event is detected or (ii) increase the rate of application of the brake activation force if amplitude of lateral acceleration increases during gradual increase of brake activation force following detection of said event.

21. (canceled)

22. (canceled)

23. (canceled)

24. A brake actuation device for a vehicle trailer including a mounting for mounting relative to the trailer, an actuator arranged to be coupled to a braking system of the trailer and movable to actuate the braking system, a movement driver for driving movement of the actuator, a sensor for sensing a predetermined condition, and a controller in communication with the sensor and arranged to operate the movement driver in response to the sensor detecting the predetermined condition, wherein the device has a retained condition in which the actuator is retained in position.

25. A brake actuation device as claimed in claim 24, wherein, in the retained condition, the actuator is mechanically restrained against movement to maintain braking force of the braking system.

26. A brake actuation device as claimed in claim 24, wherein the movement driver is powered by a power source, and the retained condition is (i) independent of supply of power from the power source to the brake actuation device or (ii) achieved mainly through mechanical retention of the actuator with only a minimal supply of power from the power source to the brake actuation device being required.

27. (canceled)

28. A brake actuation device as claimed in claim 24, wherein in the retained condition the actuator is mechanically retained in position relative to the mounting by a highly geared drive between the actuator and the powered movement driver, said drive being reversible such that it-the drive allows drive transmission from the movement driver to the actuator and drive transmission from the actuator to the movement driver.

29. (canceled)
